(19) United States
(12) Patent Application Publication
(10) Pub. No.: US 2005/0181783 A1
(43) Pub. Date: Aug. 18, 2005

(54) Mobile satellite system

(75) Inventors: Matthew Foosaner, Store Ridge, VA (US); Robert Kuhn, Fairfax, VA (US); Michael Murphy, Centernial, CO (US); Scott Jones, Reston, VA (US); David Tincher, Kearneysville, WV (US); Charlene Kutella, Leesburg, VA (US)

Correspondence Address: MORRISON & FOERSTER LLP, 1650 TYSONS BOULEVARD, SUITE 300, MCLEAN, VA, 22102, US

(73) Assignee: NEXTEL COMMUNICATIONS, INC., Reston, VA (US)

(21) Appl. No.: 10/950,682

(22) Filed: Sep. 28, 2004

Related U.S. Application Data
(60) Provisional application No. 60/506,503, filed on Sep. 29, 2003.

(51) Int. Cl. H04B 7/185

(52) U.S. Cl. 455/424

(57) ABSTRACT

A mobile cellular system and method having an antenna to transfer information between the mobile cellular system and a plurality of mobile communication devices, an extendable mast on which the antenna is mounted, a plurality of base stations to manage the transfer of information between the mobile cellular system and the plurality of mobile communication devices, a generator to supply power to the mobile cellular system, a fuel storage tank to supply fuel to the mobile cellular system, a satellite communications device to transfer information between the mobile cellular system and a communications satellite, and an air-conditioning unit to maintain a temperature inside the mobile cellular system, wherein the antenna, the extendable mast, the plurality of base stations, the generator, the fuel storage tank, the satellite communications device, and the air-conditioning unit are mounted on a self propelled vehicle.

### RELATED APPLICATION

This application claims the priority of previously filed U.S. Provisional Patent Application No. 60/506,503 filed on Sep. 29, 2003, which is herein incorporated in its entirety by reference.

### FIELD OF THE INVENTION

The present invention relates to a system for, and a method of, providing a mobile cell station for a cellular communication network wherein the mobile cell station is mounted on a vehicle that is capable of being transported on a C-130 cargo plane and is capable of being rapidly deployed by a single user.

### BACKGROUND OF THE INVENTION

Cellular phones have become a necessity of modern day life and are used by millions of people on a daily basis for routine communications such as phone calls, text messages, emails, and photographs. These communications may be of a personal nature, or as is becoming more frequent, they may be business related. Cellular phones are also used in emergencies to provide much needed communications with people in a position to provide help, and even between rescue workers as an aid to resolving crises situations.

One of the failings of cellular communications is that communications towers are needed to provide coverage to a cell area. When the towers go out of service, large areas can be without cellular service. While to some this may be a mere inconvenience, for those without access to land lines, the loss of communications may have dire ramifications. When a cellular tower becomes inoperative, it often takes several days to restore service. Such an extended period of time without cellular communications has become unacceptable. A cellular provider that could restore service quickly and seamlessly would have a substantial advantage over its competition.

Perhaps more important than the business concerns, when a loss of cellular service coincides with a natural disaster such as a hurricane, an ice storm, a wild fire, or an earthquake, the timely restoration of cellular service may save lives. When these disasters occur, it is vital to have communications restored as quickly as possible. Reliable portable communication networks have been shown to be a great asset in effectively managing disaster situations.

In more remote locations, where it is not be feasible to establish and maintain permanent communication bases, it would be extremely beneficial to be able to set up a temporary cell site for the duration of an emergency.

### SUMMARY OF THE INVENTION

An exemplary embodiment of the invention may be a mobile cellular system having an antenna to transfer information between the mobile cellular system and a plurality of mobile communication devices, an extendable mast on which the antenna is mounted, a plurality of base stations to manage the transfer of information between the mobile cellular system and the plurality of mobile communication devices, a generator to supply power to the mobile cellular system, a fuel storage tank to supply fuel to the mobile cellular system, a satellite communications device to transfer information between the mobile cellular system and a communications satellite, and an air-conditioning unit to maintain a temperature inside the mobile cellular system, wherein the antenna, the extendable mast, the plurality of base stations, the generator, the fuel storage tank, the satellite communications device, and the air-conditioning unit are mounted on a self propelled vehicle.

In a further embodiment of the invention, the mobile cellular system may be configured such that it meets the requirements to be loaded on a C-130 cargo plane.

In a further embodiment of the invention, the mobile cellular system may be configured such that it has a total weight of less than or equal to 26,000 pounds.

In a further embodiment of the invention, the mobile cellular system may be configured such that it has a weight per axel of less than or equal to 13,000 pounds.

In a further embodiment of the invention, the mobile cellular system v configured such that it has outside dimensions of 284.5 inches by 96 inches.

In a further embodiment of the invention, the antenna may be a microwave antenna.

In a further embodiment of the invention, the antenna may be omni-directional.

In a further embodiment of the invention, the antenna may be aimable.

In a further embodiment of the invention, the mast may be extendable to a height of 32 feet or greater.

In a further embodiment of the invention, the mast may be selectively tiltable.

In a further embodiment of the invention, the mast may be selectively rotateable.

In a further embodiment of the invention, the mobile cellular system may have a rack in which the base stations may be mounted such that the base stations may be inserted or removed from a front side of the rack.

In a further embodiment of the invention, the generator may be rated at 15 kilowatts.

In a further embodiment of the invention, the fuel tanks may be able to supply power to the mobile cellular system for at least four days of continuous operation.

In a further embodiment of the invention, the mobile cellular system may include a fuel selector to allow a user to selectively draw fuel from the fuel storage tank or a vehicle fuel tank.

In a further embodiment of the invention, the satellite communications device may be a satellite dish.

In a further embodiment of the invention, the satellite dish may be mounted on a side of the mobile cellular system.

In a further embodiment of the invention, the satellite dish may be connected to the mobile cellular system using a flexible waveguide.

In a further embodiment of the invention, the satellite dish may be manually positionable.

In a further embodiment of the invention, the satellite dish may be automatically positionable.

In a further embodiment of the invention, the mobile cellular system may include a control device to control extending the extendable mast, wherein the control device may be operational from a top of the mobile cellular system.

In a further embodiment of the invention, the control device may be effectively connected to the mobile cellular system by a cable.

In a further embodiment of the invention, cables connecting the mast to the mobile cellular system do not need to be disconnected during extension or retraction of the mast, or prior to operation following the extension or retraction of the mast.

In a further embodiment of the invention, a CDL may not be required to drive the mobile cellular system.

Another exemplary embodiment of the invention is a method for providing cellular communications. The method includes providing a self propelled mobile cellular system having a cellular antenna to transfer data to and from a plurality of mobile communications devices, and a satellite communications device to transfer data to and from a satellite, and transmitting information to the mobile cellular system using a microwave antenna.

A method according to a further embodiment of the invention may include transporting the mobile cellular system to an area where cellular communications are to be provided, using a C-130 cargo plane.

Another exemplary embodiment of the invention may include a cellular network having a plurality of mobile cellular systems to establish cellular coverage over a plurality of areas wherein the mobile cellular systems, transfer data with each other using microwave antennas, transfer caller data between the mobile cellular systems and a plurality of mobile communication devices using cellular antennas mounted on the mobile cellular systems, and transfer the caller data between the mobile cellular systems and at least one communication satellite using satellite dishes mounted on the mobile cellular systems.

### DESCRIPTION OF THE FIGURES

FIG. 1 shows a side view of an example of a preferred embodiment of a mobile satellite system mounted on a light truck.

FIG. 2 shows an example of a side view of the preferred embodiment of the mobile satellite system shown in FIG. 1 having an extended mast.

FIG. 3 shows an example of a system to rotate a mast according to the preferred embodiment of the mobile satellite system shown in FIG. 1.

FIG. 4 shows an example of a side view of the preferred embodiment of a mobile satellite system shown in FIG. 3 having a deployed satellite dish.

FIG. 5 shows an example of a deployed satellite dish according to an embodiment of the invention.

FIG. 6 shows an example of a deployed satellite dish according to the preferred embodiment of the invention shown in FIG. 1.

FIG. 7 shows an example of an overhead view of the preferred embodiment of a mobile satellite system shown in FIG. 1.

FIG. 8 shows an example of a rear view of the mobile satellite system shown in FIG. 1 having an open concession style door.

FIG. 9 shows an example of an opposite side view of the preferred embodiment of a mobile satellite system shown in FIG. 1 having an open concession style door.

### DETAILED DESCRIPTION

While several embodiments of the present invention are described below, the descriptions are exemplary, and are not intended to limit the scope of the invention. One of ordinary skill in the art would recognize that the embodiments may be altered without changing the scope of the invention.

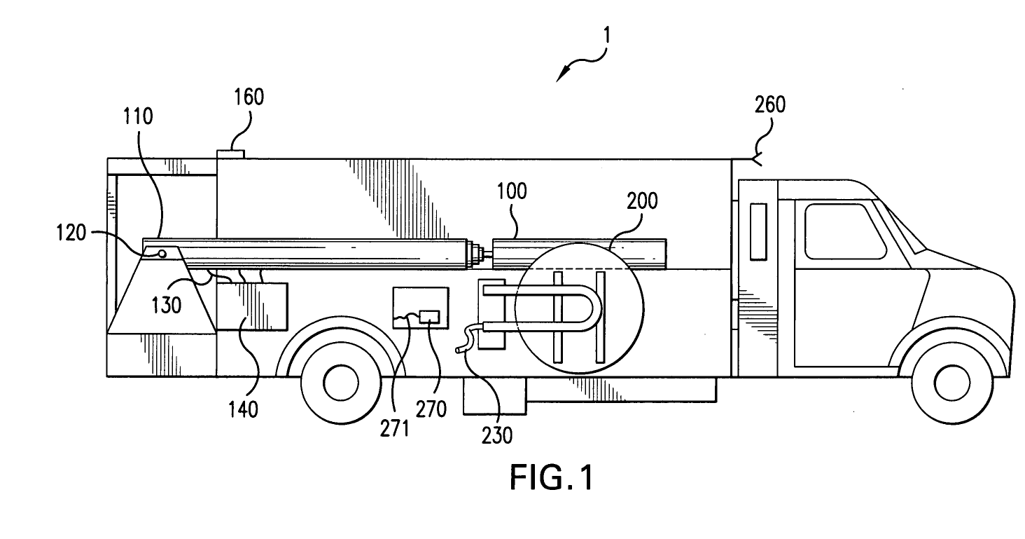

A preferred embodiment of the invention is illustrated in FIGS. 1-9, wherein like reference numerals refer to like components. The preferred embodiment shown in FIG. 1 illustrates a mobile satellite system mounted on a light truck. The system may be so mounted to allow increased flexibility of deployment while reducing the time and expense of deployment.

By mounting a complete cellular system on a light truck such as shown in FIG. 1, the preferred embodiment facilitates rapid deployment to provide cellular service in areas where normal cell service is disrupted, or in areas that do not have normal cell service. In one embodiment, the light truck may be a Ford F-650. To further enhance the range of deployment of the preferred embodiment, the mobile cellular system may be designed such that it meets the standard dimension and the axel weight requirements necessary for a vehicle to be transported on a C-130 cargo plane. By meeting these requirements, the mobile cellular system greatly increases the range throughout which it may be deployed, thus allowing a small fleet of mobile cellular systems to rapidly provide cellular service worldwide. In an embodiment, the weight per axel does not exceed approximately 13,000 pounds.

To further improve response time and ease of deployment, the preferred embodiment may be under the gross weight limit for vehicles requiring a driver to have a Commercial Drivers License (CDL), usually about 26,000 pounds. The reason this is such a benefit is that when a CDL is required to drive a vehicle, the cost of rapidly deploying the vehicle becomes very expensive. Possible drivers must be trained and licensed, and then those licensed drivers must be kept available to drive with little notice. In embodiments where the mobile cellular system does not require an operator to have a CDL, a single operator may operate the cellular portion of the system and may also be the driver.

In the preferred embodiment shown in FIG. 1, the mobile cellular system has an antenna 100 mounted on an extendable mast 110. The antenna may be used to communicate with a plurality of mobile communication devices present in the area covered by the mobile cellular system. In the preferred embodiment, the antenna may be an omni-directional antenna to allow for wide coverage and ease of positioning. In an alternate embodiment, a directional antenna may be used to improve the quality of data transfer over a chosen area while conserving power. In a further embodiment, the radiation patterns of the antenna may be changed by the operator.

In order to remain within the preferred dimensions as described above, the antenna 100 and the extendable mast 110 may pivot around a pivot 120 such that they may be stored in a horizontal position when not operational. As shown in FIG. 1, the mast 110 and the antenna 100 may be stored on a side of the light truck when not in use. It is preferable to store these components on the side of the truck to minimize the height of the mobile satellite system. In the preferred embodiment, the mast 110 may be extendible to a height of greater than about thirty two feet above the ground to ensure that a barrier is not required by FCC regulations. In alternate embodiments, the mast 110 may be extendable to greater heights to provide wider coverage.

FIG. 1 also shows a microwave antenna support 160. The microwave antenna support 160 may be used to secure a microwave antenna that may be used to transfer T1 data between the mobile cellular system and other mobile cellular systems or stationary satellite systems to establish a more robust cellular network.

Also shown in FIG. 1 is a satellite dish 200 which may be used to transfer data between the mobile cellular system and a communications satellite. In the preferred embodiment, the satellite dish 200 may be mounted vertically on the side of the light truck as shown in FIG. 1. By mounting the satellite dish 200 in a vertical position, the overall height of the mobile cellular system can be reduced such that the system remains within the desired dimensions. In the preferred embodiment, the satellite dish 200 may be operatively connected to the mobile cellular system using a flexible wave guide 230. By using a flexible wave guide 230, the satellite dish 200 can be repositioned as detailed below, without having to disconnect and reconnect cables, while maintaining a clear signal.

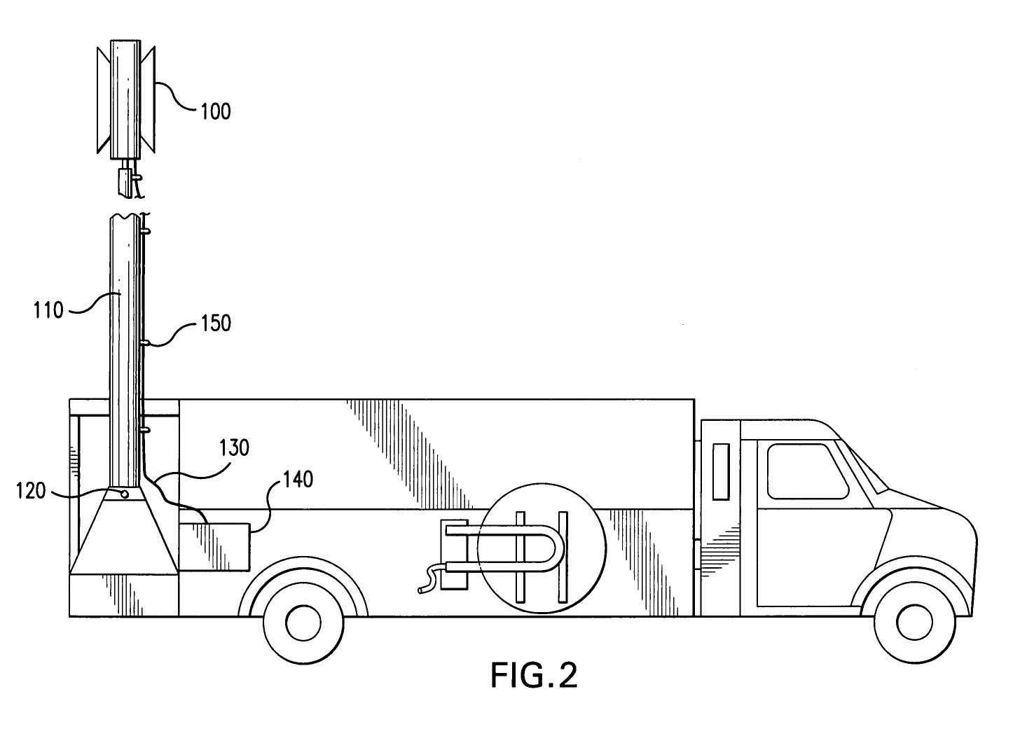

FIG. 2 shows an example of the preferred embodiment shown in FIG. 1 where the mast 110 is pivoted around pivot 120 until it is in a vertical position. While the mast 110 is shown in the vertical position, it should be noted that the mast can be secured at any angle between the horizontal storage position and a fully deployed vertical position. By enabling the mast 110 to be secured at various angles, it may be possible to improve coverage when the mobile cellular system is parked on uneven or unleveled ground. It is also possible to better aim the antenna if desired.

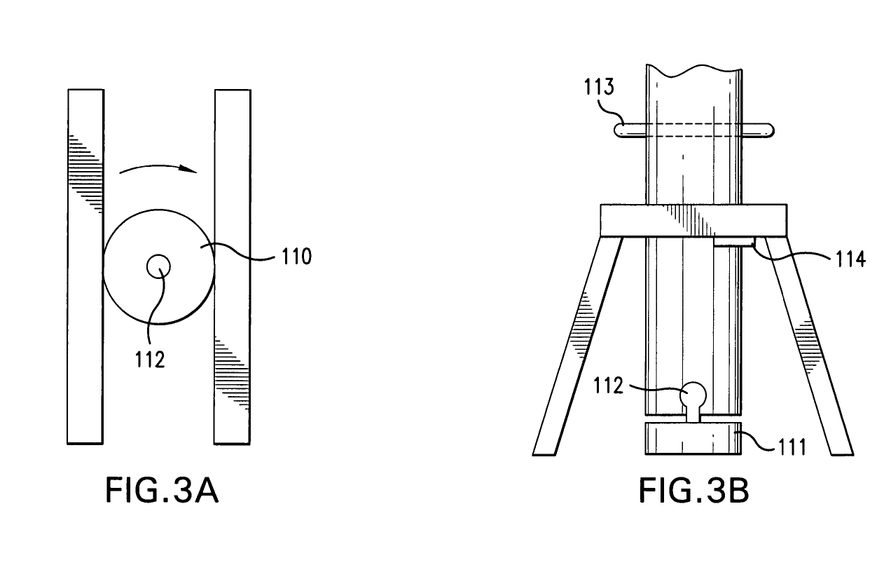

It is sometimes preferable to rotate the mast 110 about its axis to position the antenna for optimal coverage. To facilitate rotation of the mast 110, the mobile cellular system shown in the preferred embodiment may have the additional features shown in FIG. 3. Specifically, the mobile cellular system may employ a mast base 111 having a rotational ball 112. The mast base 111 may be secured to the frame of the mobile cellular system such that it can support the full weight of the mast 110. The mast may be free to pivot about the rotational ball 112. A rotational lock 114 is provided to secure the mast 110 in position when the desired alignment is achieved. When the operator wishes to rotate the mast 110, the rotational lock 114 may be disengaged and a rotation rod 113 may be inserted through the mast 110 to assist the operator in generating additional torque. The operator may then apply force to the rotational rod 113 and positions the mast at the desired alignment and the rotational lock 114 may then be engaged to secure the mast 110. In alternate embodiments the mast may be automatically rotated, but the preferred embodiment uses a manual rotation system to reduce the gross weight of the mobile cellular system.

In the preferred embodiment shown in FIG. 2, the mast 110 may be effectively connected to the mobile cellular system using a plurality of cables 130. When the mast 110 is stored in the horizontal position, the cables 130 may be stored in a cable box 140. The cables 130 may be stored in the cable box 140 such that when the mast 110 is extended, the cables 130 are drawn from the cable box 140, and when the mast 110 is then retracted, the cables 130 return to the cable box 140. This allows the mobile cellular system to be deployed without requiring an operator to disconnect and reconnect the cables 130 and the mast 110. In the preferred embodiment, the cables may be secured to the mast using a series of carabineers 150. By using the carabineers 150, the mast 110 can be quickly extended or retracted without requiring an operator to strap down the cables 130 every time. This allows one operator to quickly and efficiently deploy the mobile cellular system.

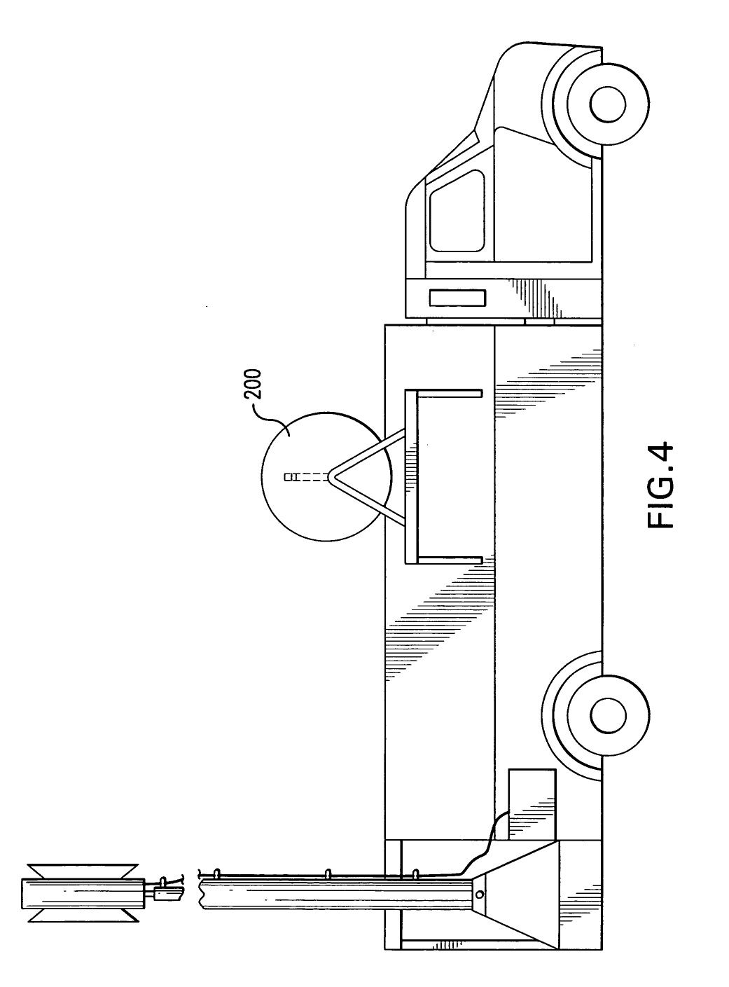

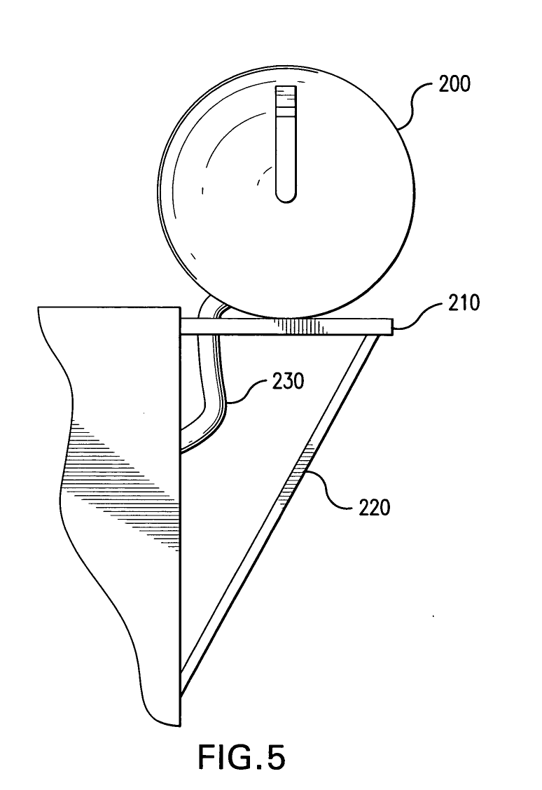

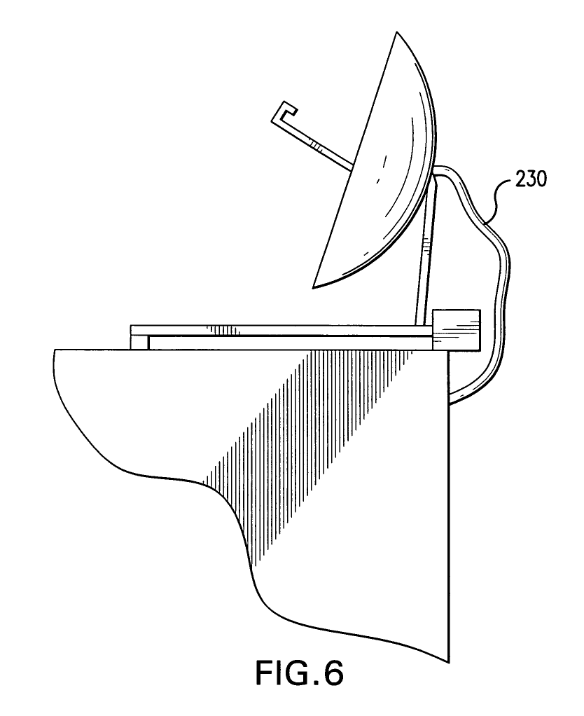

FIG. 4 depicts an example of the preferred embodiment shown in FIG. 1 having the satellite dish 200 deployed. While the satellite dish 200 is not deployed, it may be secured to the side of the mobile cellular system using a variety of securing devices depending on the embodiment. When the operator wishes to deploy the satellite dish 200, the dish 200 may be disengaged from the side of the system. When the satellite dish 200 is disengaged, it may be rotated into a horizontal position by the operator. As shown in FIG. 5, when the dish support 210 is positioned in a horizontal position, it may then be secured in place using the dish deployment rod 220. While the deployment rod 220 is shown, a variety of other devices can be used to secure the dish support in the horizontal position. In alternate embodiments, the satellite dish 200 and the dish support 210 can be positioned on the roof of the mobile cellular system after the dish support 210 is rotated into the horizontal position, thus allowing the roof to bear the weight of the satellite dish 200 as shown in FIG. 6.

In the preferred embodiment, once the satellite dish 200 is deployed, it may then be aimed at one of a plurality of communications satellites before transferring data. According to the preferred embodiment, the satellite dish 200 may be automatically aimed based on the operator's selection of a desired communications satellite. According to an alternate embodiment, the satellite dish 200 may be manually aimed by the operator.

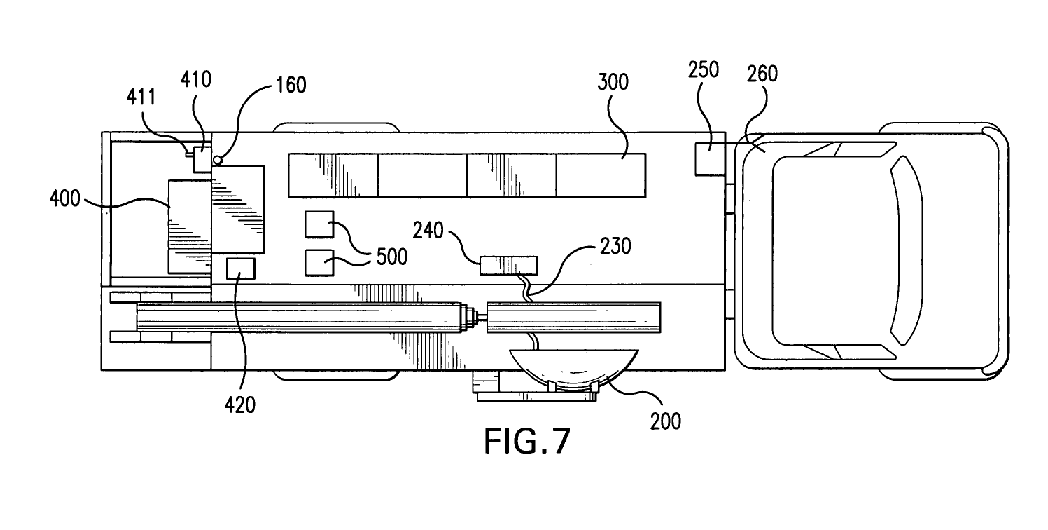

FIG. 7 shows an example of an overhead interior view of the preferred embodiment of FIG. 1. The interior view is provided to show some of the possible components of the mobile cellular system as well as possible configurations thereof. As shown in FIG. 7, the preferred embodiment uses a plurality of satellite modems 240 connected to the satellite dish 200 by the flexible wave guide 230. Using a plurality of satellite modems 240 allows for a more robust system with greater flexibility. If a satellite modem 240 fails, the system may be operated without it, or the operator can replace it without having to take the system out of service. Alternate embodiments may use a single satellite modem 240 connected to a multiplexer wherein the multiplexer could be used to send multiple transmissions through the single satellite modem 240.

The preferred embodiment of the mobile cellular system shown in FIG. 7 may also utilize a plurality of base radios 300 to control data transfer between the plurality of mobile communication devices and the cellular network. The base radios 300 may be rack mounted as shown in FIG. 7 to provide better operator access. If a base radio 300 needs to be replaced due to failure or other reasons, the base radio 300 can be horizontally removed from the rack without having to disconnect the other base radios 300.

FIG. 7 also shows a GPS unit 250 having an externally mounted GPS antenna 260. The preferred embodiment may use at least one GPS unit 250 to determine the location of the mobile cellular system. The GPS unit 250 may be used as an aid to efficiently aim the satellite dish 200 and to assist the operator in positioning the mobile cellular system in a predetermined location that provides provide increased cellular coverage. According to the preferred embodiment, the GPS antenna 260 may be located at either the front or the back of the mobile cellular system. The GPS antenna 260 is so located to stay out of the signal “shadow” of the satellite dish 200, the mast 110, and the antenna 100. In a further embodiment, the GPS antenna 260 may be movable in relation to the mobile cellular system.

Also shown in FIG. 7, the preferred embodiment may utilize a generator 400 to power the mobile cellular system. The generator 400 may be rated at about 15 kW. The preferred embodiment may also use a plurality of generator fuel tanks 410 to fuel the generator 400. It is preferable to use a plurality of generator fuel tanks 410 rather than a single generator fuel tank because the plurality of generator fuel tanks 410 can be located in various places on the mobile cellular system to distribute the weight of the generator fuel tanks 410 and the fuel. In the preferred embodiment, the generator fuel tanks 410 may be sized to allow continuous operation of the mobile cellular system for one week. The preferred embodiment may also have a fuel selector switch 411 to allow the operator to use fuel from the generator fuel tanks 410 or from the vehicle fuel tank to power the mobile cellular system.

The preferred embodiment shown in FIG. 7 uses a plurality of air-conditioning units 500 to maintain a desired temperature inside the mobile cellular unit. The air-conditioning units 500 may be capable of both cooling and warming the air, although the other components generally produce enough heat such that only the cooling function is utilized. In the preferred embodiment, the air intake to the air-conditioning units 500 should be located away from the exhaust ports of the generator 400 and the light truck. By locating these components away from each other, the air-conditioning unit 500 is not forced to cool hot exhaust air, and therefore operating at an increased efficiency.

Careful consideration is given to the location of the various components of the mobile cellular system shown in FIG. 7. Care should be taken to balance the system such that the weight per axel is evenly distributed and the side-to-side balance is evenly distributed. While balance is a factor in transportability on a C-130 cargo plane, it is also related to safe and proper operation of the vehicle. Access to the components may also be a consideration in the placement of the components. The components in the preferred embodiment are placed in such a way that a single operator can quickly and efficiently deploy the mobile cellular system.

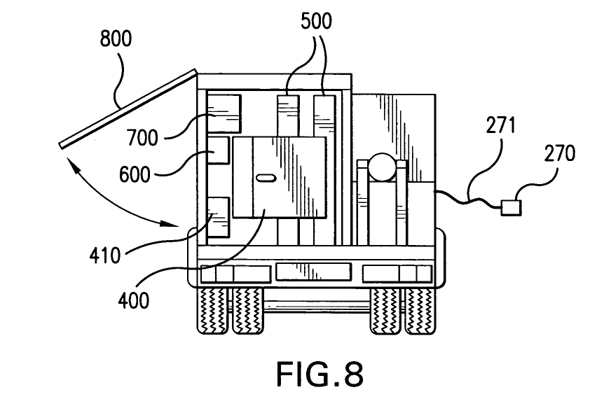

FIG. 8 shows an example of a rear view of the preferred embodiment shown in FIG. 1. As shown in FIG. 8, the generator 400 is located such that it is easily accessible to the operator. Also shown in FIG. 8 is an external power hookup 600. The external power hookup 600 may be used to accept commercial power from an external source to power the mobile cellular system. The external power hookup 600 may be used when the mobile cellular system is deployed in areas with external power. The external power hookup 600 may be particularly useful when the generator needs to be taken off-line for maintenance or servicing during extended deployment. Shown located above the external power hookup 600 is a combination breaker panel and surge arrestor 700. The panel 700 may be used to manage the power distribution of the mobile cellular system.

In the preferred embodiment, the mobile cellular system may have a battery backup system 420 (shown in FIG. 7) that is capable of powering the mobile cellular system for several hours without the generator 400. The battery backup 420 may be used so that the system can remain operable when the generator 400 is taken out of service for reasons such as repairs or refueling.

FIG. 8 also shows a concession style door 800 that is used to access the rack mounted base radios 300 located inside the mobile cellular system. The concession style door 800 may be used for multiple reasons. Using the concession style door 800 in conjunction with side facing base radios 300 may provide environmental protection to the equipment and the operator while allowing an unencumbered access to the base radios 300 and other equipment which may be located in the vicinity of the base radios 300. In the preferred embodiment, the concession style door 800 may be mounted such that there is enough clearance between the base radios 300 and the concession style door 800 that the operator may fit in the space when the concession style door 800 is closed. This allows the operator to seek refuge in the compartment that is formed while deploying the mobile cellular system in the event of extreme environmental conditions.

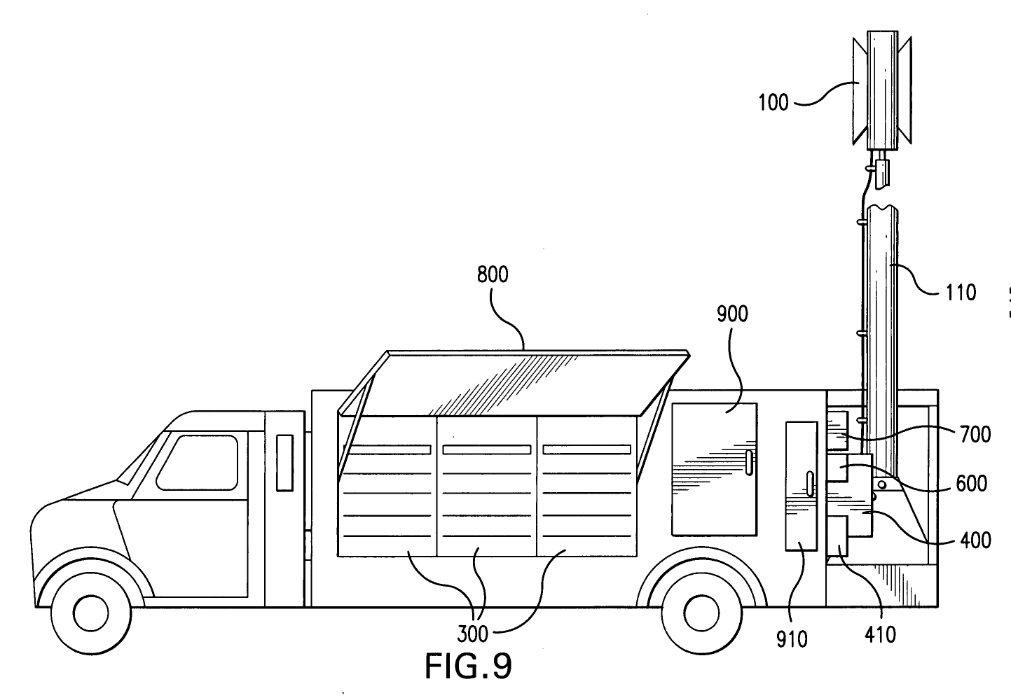

FIG. 9 shows an example of the mobile cellular system of FIG. 1 from the opposite side. In FIG. 9, the concession style door 800 is shown in an open position such that the base radios 300 are exposed. Access door 900 is shown positioned to the rear of the concession style door 800 in the preferred embodiment. The access door 900 may be used by the operator to enter the mobile cellular system so that he may enter a crawl space. From the crawl space, the operator can access the rear connections of the base radios 300 as well as the generator 400, the air-conditioning units 500, the external power hookup 600, the breaker panel 700, and various other components depending on the embodiment.

An access hatch 910 is also shown in the preferred embodiment. The access hatch 910 may be used to access components internal to the mobile cellular system.

One of the features of the preferred embodiment is that it may be quickly and easily deployed by a single operator, and many facets of the design have been chosen with this in mind. Accordingly, the preferred embodiment may use a remote control device 270 as shown in FIGS. 1 and 8. While the Figures show the remote control 270 connected to the mobile cellular system with a control cable 271, which may be retractable, the remote control 270 according to another preferred embodiment may instead transmit data wirelessly to the mobile cellular system. The remote control 270 may be used to perform various functions according to the preferred embodiment, examples of these functions include, but are not limited to, extending the mast 110, retracting the mast 110, rotating the mast 110, tilting the mast 110, aiming the antenna 100, securing the mast 110, unsecuring the mast 110, deploying the satellite dish 200, aiming the satellite dish 200, starting the generator 400, stopping the generator 400, and switching the fuel selector switch 411. In a preferred embodiment where a control cable 271 is used to connect the remote control 270 to the mobile satellite system, the control cable 271 has a sufficient length to reach the opposite side of the mobile cellular system, as well as the roof of the mobile cellular system. It is preferable to have the remote control 270 operable in the areas surrounding the mobile cellular system such that a single operator can deploy the system quickly, efficiently, and safely.

In the preferred embodiment, the mobile cellular system may have an air ride suspension to help minimize impact damage to the components contained therein. Air can be released or added to the suspension to change the effective height of the mobile cellular system. This may be helpful in balancing the mobile cellular system or in driving the mobile cellular system under structures having a low clearance.

Additional embodiments involve a method for providing cellular coverage that may use mobile cellular systems to provide cellular coverage to areas where cellular coverage does not exist. The cellular coverage may not exist due to a failure of existing cellular systems, or coverage may never have been present in the area.

1. A mobile cellular system comprising:
an antenna to transfer information between the mobile cellular system and a plurality of mobile communication devices,
an extendable mast on which the antenna is mounted,
a plurality of base stations to manage the transfer of information between the mobile cellular system and the plurality of mobile communication devices,
a generator to supply power to the mobile cellular system,
a fuel storage tank to supply fuel to the mobile cellular system,
a satellite communications device to transfer information between the mobile cellular system and a communications satellite, and
an air-conditioning unit to maintain a temperature inside the mobile cellular system,
wherein the antenna, the extendable mast, the plurality of base stations, the generator, the fuel storage tank, the satellite communications device, and the air-conditioning unit are mounted on a self propelled vehicle.

2. The mobile cellular system of claim 1, wherein the mobile cellular system is configured such that it meets the requirements to be loaded on a C-130 cargo plane.

3. The mobile cellular system of claim 1, wherein the mobile cellular system is configured such that it has a total weight of less than or equal to 26,000 pounds.

4. The mobile cellular system of claim 1, wherein the mobile cellular system is configured such that it has a weight per axel of less than or equal to 13,000 pounds.

5. The mobile cellular system of claim 1, wherein the mobile cellular system is configured such that it has outside dimensions less than or equal to 284.5 inches by 96 inches.

6. The mobile cellular system of claim 1, wherein the antenna is a microwave antenna.

7. The mobile cellular system of claim 1, wherein the antenna is omni-directional.

8. The mobile cellular system of claim 1, wherein the antenna is a aimable.

9. The mobile cellular system of claim 1, wherein the mast is extendable to a height of 32 feet or greater.

10. The mobile cellular system of claim 1, wherein the mast is selectively tiltable.

11. The mobile cellular system of claim 1, wherein the mast is selectively rotateable.

12. The mobile cellular system of claim 1, further comprising a rack in which the base stations are mounted such that the base stations may be inserted or removed from a front side of the rack.

13. The mobile cellular system of claim 1, wherein the generator is rated at 15 kilowatts.

14. The mobile cellular system of claim 1, wherein the fuel tanks can supply power to the mobile cellular system for at least four days of continuous operation.

15. The mobile cellular system of claim 1, further comprising a fuel selector to allow a user to selectively draw fuel from the fuel storage tank or a vehicle fuel tank.

16. The mobile cellular system of claim 1, wherein the satellite communications device is a satellite dish.

17. The mobile cellular system of claim 16, wherein the satellite dish is mounted on a side of the mobile cellular system.

18. The mobile cellular system of claim 16, wherein the satellite dish is connected to the mobile cellular system using a flexible waveguide.

19. The mobile cellular system of claim 1, wherein the satellite dish is manually positionable.

20. The mobile cellular system of claim 1, wherein the satellite dish is automatically positionable.

21. The mobile cellular system of claim 1, further comprising a control device to control extending the extendable mast, wherein the control device is operational from a top of the mobile cellular system.

22. The mobile cellular system of claim 1, wherein the control device is effectively connected to the mobile cellular system by a cable.

23. The mobile cellular system of claim 1, wherein cables connecting the mast to the mobile cellular system are not disconnected during extension or retraction of the mast, or prior to operation following the extension or retraction of the mast.

24. The mobile cellular system of claim 1, wherein a CDL is not required to drive the mobile cellular system.

25. A method for providing cellular communications, the method comprising: providing a self propelled mobile cellular system having a cellular antenna to transfer data to and from a plurality of mobile communications devices, and a satellite communications device to transfer data to and from a satellite, and transmitting information to the mobile cellular system using a microwave antenna.

26. The method of claim 25, further comprising transporting the mobile cellular system to an area where cellular communications are to be provided, using a C-130 cargo plane.

27. A cellular network comprising:
a plurality of mobile cellular systems to establish cellular coverage over a plurality of areas wherein the mobile cellular systems,
transfer data with each other using microwave antennas,
transfer caller data between the mobile cellular systems and a plurality of mobile communication devices using cellular antennas mounted on the mobile cellular systems, and
transfer the caller data between the mobile cellular systems and at least one communication satellite using satellite dishes mounted on the mobile cellular systems.
